(19) United States
(12) Patent Application Publication
(10) Pub. No.: US 2009/0302505 A1
(43) Pub. Date: Dec. 10, 2009

(54) INJECTABLE CORING COMPOSITION FOR CLOSED MOLDING PROCESSES

(75) Inventors: Brian M. Kruchten, Royalton, MN (US); Kimberly A. Whitley, Largo, FL (US); Louis P. Schaefer, Trinity, FL (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Illinois Tool Works Inc., Glenview, IL (US)

(21) Appl. No.: 11/917,388

(22) PCT Filed: Jun. 8, 2006
(86) PCT No.: PCT/US06/22249

§ 371 Date: Jul. 20, 2009

Related U.S. Application Data
(60) Provisional application No. 60/689,994, filed on Jun. 13, 2005.

(51) Int. Cl. B29C 35/08; C08K 7/18; B29C 45/00; C08K 7/20; C08K 7/16; C08L 67/00

(52) U.S. Cl. 264/478; 524/80; 524/599

(57) ABSTRACT

An injectable coring composition. The injectable coring composition comprises: about 70 to about 90 wt % polyester resin, about 0.1 to about 5 wt % monomer, about 0.1 to about 5 wt % solvent, about 1 to about 25 wt % spheres or microspheres, the spheres or microspheres made of glass, plastic, ceramic, or combinations thereof, and 0 to about 25 wt % filler. A method of making a core is also disclosed.

The present application is related to U.S. application Ser. No. 10/643,048 filed Aug. 18, 2003, entitled “Method of Making a Composite With a Barrier Layer in a Closed Mold Process and Composite Produced Thereby,” which is a continuation-in-part of U.S. application Ser. No. 10/262,853 filed Oct. 2, 2002, entitled “Method of Making a Sheet of Building Material”, which is a continuation-in-part of U.S. application Ser. No. 09/799,211 filed Mar. 5, 2001, entitled “Wood Replacement System and Method,” now U.S. Pat. No. 6,463,871, the disclosures of which are hereby incorporated by reference.

This invention relates generally to coring compositions, and more particularly to an injectable coring composition for use in a closed mold process.

Some composite parts comprise a wood core encased in fiberglass. Such parts can be used for hatch covers and latch doors for a boat, for example. The composite parts are made by routing the wood core, placing it in a closed mold, and adding the fiberglass to form the final part.

However, water permeation into the wood core of the composite part can cause the wood to rot, creating structural problems which weaken the part.

Other composite parts, such as tractor hoods and bumpers, use other types of cores, including, but not limited to, foam cores and honeycomb cores. These cores are often machine shaped, making it difficult to maintain a uniform core shape.

In addition, resin coating compositions often contain a polyester or vinyl ester resin and a monomer, such as styrene, as part of the formulation. The polyester resin itself may also have a monomer content, adding to the total amount of monomer present in the barrier resin coating composition. Thus, unsaturated polyester resins typically contain volatile organic monomers, such as styrene. In commercially available unsaturated polyester resin applications, up to 50% of styrene or other vinyl monomers are used. Some of the organic monomer is usually lost in the atmosphere during application and curing, causing occupational safety hazards. This is also a problem because of environmental considerations. In many countries, legislation introduced in recent years requires a reduction in the amount of VOC which may be released to the atmosphere.

Reducing the monomer content in unsaturated polyester resins has been a challenge for decades in the polyester composite and coating industry. See, for example, U.S. Pat. Nos. 6,583,218 and 6,794,483.

Likewise, reducing the overall monomer content in gel coats and barrier coats has also been a challenge in the coating industry. See, for example, U.S. Pat. Nos. 6,808,821 and 5,773,531.

The need remains for an improved injectable coring composition, and for methods of making cores having a consistent shape.

The present invention meets this need by providing an injectable coring composition. The injectable coring composition comprises: about 70 to about 90 wt % polyester resin, about 0.1 to about 5 wt % monomer, about 0.1 to about 5 wt % solvent about 1 to about 25 wt % spheres or microspheres, the spheres or microspheres made of glass, plastic, ceramic, or combinations thereof, and 0 to about 25 wt % filler.

Another aspect of the invention involves a closed mold process using the injectable coring composition. The method involves providing an injectable resin composition; adding a catalyst to the injectable resin composition; injecting the injectable resin composition into a closed mold; curing the injecting resin composition to form the core; and removing the cured core.

The injectable coring composition can be used to make a replacement for the core in a composite part. The cores are primarily used for non-structural composite parts, although it not limited to non-structural parts. For example, it can be used to replace the wood core in a non-structural fiberglass/wood composite, such as the hatch covers or latch doors for a boat. The injectable coring composition is injected into a closed mold and cured. The cured core is removed from the closed mold, and can then be used as the core for the fiberglass part. The core can also be used to replace foam and honeycomb cores in other composite parts, such as tractor hoods and bumpers.

A core made from the coring composition of the present invention generally can have a number of advantages. However, it is emphasized that it need not have all of these advantages to be effective.

The core made of the coring composition will not rot on exposure to water. When used as a replacement for a wood core, there is less waste from cutting wood. In addition, parts can be made whenever they are needed, reducing the necessity of having a large inventory on hand. The coring composition has a high strength to weight ratio. It can have a low VOC level (i.e., less than 30%), if desired. The chemical bond improves the adhesion characteristics.

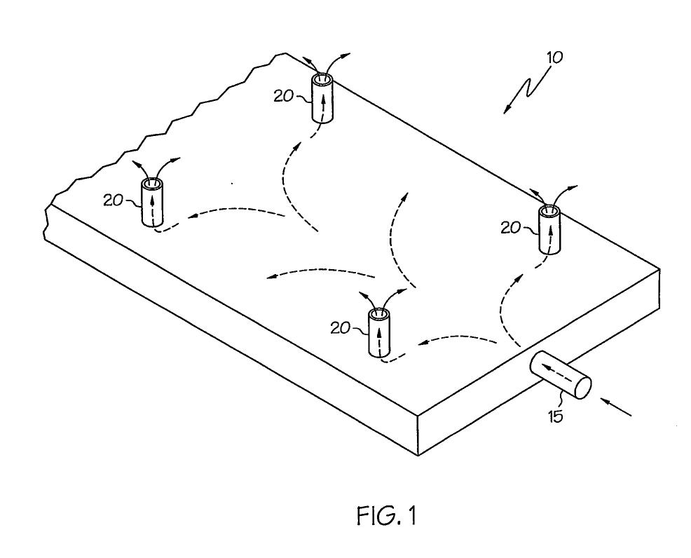

FIG. 1 shows a typical closed mold 10 for use with the injectable coring composition of the present invention. The closed mold 10 has an inlet 15 where the coring composition is injected. The coring composition flows through the inlet 15 into inside of the closed mold. There are air outlets 20 which allow the air to flow out of the closed mold 10 as the coring composition is injected into the closed mold.

The injectable coring composition of the present invention can be used with a standard dispensing equipment to inject it into the closed mold. It can be injected without using a high pressure system.

Parts can be made using the injectable coring composition of the present invention up to about 1.5 inches thick, or more if desired.

The coring composition includes polyester resin. Typically, the coring composition includes between about 70 to about 90 wt % polyester resin. (All percentages are based on the total weight of the coring composition.) The polyester resin component is typically a combination of two or more unsaturated polyesters. Suitable polyester resins include, but are not limited to, orthophthalic polyester resins, isophthalic resins, dicyclopentadiene (DCPD) polyester resins, or combinations thereof. In one embodiment, the resin component includes an orthophthalic polyester resin in a range of about 40 to about 60 wt %, typically about 45 to about 55 wt %, and DCPD in an amount of about 20 to about 40 wt %, typically about 25 to about 35 wt %. In another embodiment, the resin component includes an orthophthalic polyester resin in a range of about 30 to about 50 wt %, typically about 35 to about 45 wt %, and DCPD in a range of about 30 to about 50 wt %, typically about 35 to about 45 wt %.

The coring composition generally includes a monomer in an amount of between about 0.1 to about 5 wt %. Suitable monomers include, but are not limited to, styrene, diallyldimethylammonium chloride, and methylmethacrylate (MA). Alternatively, a non-styrenic, low to no VOC material can be used. Suitable low to no VOC materials include, but are not limited to, diacrylates and triacrylates. Suitable diacrylates and triacrylates, include, but are not limited to, modified polyetherpolyol acrylate, trimethylolpropanetriacrylate, ethoxylated trimethylolpropanetriacrylate, and 1-3 butylene glycol dimethacrylate.

The coring composition can include a solvent in an amount between about 0.1 to about 5 wt %. Suitable solvents include, but are not limited to, alpha methylstyrene, styrene, and MMA.

The coring composition can include an adhesion promoter in an amount between about 0.1 and about 5 wt %. Suitable adhesion promoters include, but are not limited to, organofunctional silanes. Suitable organofunctional silanes include, but are not limited to, glycidoxypropyltrimethoxysilane.

The coring composition can include a surface modifier in an amount between about 0.1 and about 5 wt %. Suitable surface modifiers include, but are not limited to, siloxanes. Suitable siloxanes include, but are not limited to, polyether modified polydimethylsiloxanes.

The coring composition can also include one or more accelerators. The accelerators are generally present in an amount of between about 0.1 to about 5 wt %. Typical accelerators include, but are not limited to, dimethyl para-toluidine, dimethyl aniline, diethyl aniline (DEA), dimethyl acetalacetamide, cobalt octoate, potassium octoate, copper naphthanate, quaternary ammonium salts, or mixtures thereof.

The coring composition can include an air release additive. Air release additives include, but are not limited to, silicone free solutions of foam destroying polymers. Suitable air release additives are available from BYK Chemie, such as BYK 555.

The coring composition can include a wetting and dispersing additive. Wetting and dispersing additives include, but are not limited to, solutions of a salt of unsaturated polyamine amides and acidic polyesters. Suitable wetting and dispersing additives are available from BYK Chemie, such as BYK 966.

The coring composition includes hollow spheres or microspheres. Suitable hollow spheres or microspheres can be made of materials including, but not limited to, glass, including silicate glass, ceramic, or plastic, or combinations thereof. Generally, the spheres/microspheres are present in an amount of about 1 to about 25 wt %. Typically, plastic spheres/microspheres are present in an amount from about 1 to about 10 wt %, glass spheres/microspheres in an amount from about 5 to about 18 wt %, and ceramic spheres/microspheres in an amount of about 10 to about 25 wt %.

The ratio of the various types of microspheres can vary. In some embodiments, the microspheres are mostly glass (for example more than about 60 wt %, or more than about 70 wt %, or more than about 75 wt %, or more than about 80 wt %, or more than about 85 wt %, or more than about 90 wt %), while in others, about the same amount of glass and plastic microspheres are used (for example, about 45 to about 55 wt % glass and about 55 to about 45 wt % plastic).

The coring composition can also include one or more fillers, which are usually present in an amount of between 0 to about 25 wt %. Typical fillers include, but are not limited to, wollastonite fibers, mica, potassium aluminum silicate, calcium silicate, calcium sulfate, aluminum trihydrate, carbon fibers, ceramic fibers, or combinations thereof.

The coring composition can be made by mixing the polyester or vinyl ester resin, monomer, solvent, adhesion promoter, surface modifier, and other additives in a conventional mixer. The accelerators are added and mixed, typically for about 5 minutes. The fillers (if any) are then added and mixed into the composition for about 20 minutes to form the coring composition.

A catalyst is added to the coring composition before injecting the composition into the closed mold. Suitable catalysts include, but are not limited to, methylethylketone peroxide (MEKP), cumylhydroperoxide (CHP), and benzoyl peroxide (BPO).

One typical coring composition includes about 40 to about 60 wt % orthophthalic polyester resin, about 20 to about 40 wt % DCPD polyester resin, about 0.1 to about 5 wt % monomer, about 0.1 to about 5 wt % solvent, about 0.1 to about 5 wt % adhesion promoter, about 0.1 to about 5 wt % surface modifier, about 0.1 to about 5 wt % accelerators, about 1 to about 25 wt % glass and plastic microspheres, 0 to about 25 wt % fillers, and a catalyst.

### EXAMPLE 1

| | |
|---|---|
| Unsaturated Polyester (orthophthalic) | 43.6% |
| Unsaturated Polyester (DCPD) | 32.5% |
| Solvent (Alpha Methylstyrene) | 1.5% |
| Monomer (Diallyldimethylammonium chloride) | 0.4% |
| Monomer (Styrene) | 3.0% |
| Organofunctional silane | 0.05% |
| (Glycidoxypropyltrimethoxysilane) | |
| Polyether modified polydimethylsiloxane | 0.3% |
| Copper Napth 8% | 0.02% |
| 12% Cobalt Octoate | 0.2% |
| 15% Potassium | 0.1% |
| N,N-Diethyl aniline | 0.1% |
| Polymeric microspheres | 1.2% |
| Glass microspheres | 17% |

Another embodiment of the present invention includes about 30 to about 50 wt % orthophthalic polyester resin, about 30 to about 50 wt % DCPD polyester resin, about 0.1 to about 5 wt % monomer, about 0.1 to about 5 wt % solvent, about 0.1 to about 5 wt % adhesion promoter, about 0.1 to about 5 wt % surface modifier, about 0.1 to about 5 wt % air release additive, about 0.1 to about 5 wt % wetting and dispersing additive, about 0.1 to about 5 wt % accelerators, about 1 to about 25 wt % glass and plastic microspheres, 0 to about 25 wt % fillers, and a catalyst.

### EXAMPLE 2

| | |
|---|---|
| Unsaturated Polyester (orthophthalic) | 37.3% |
| Unsaturated Polyester (DCPD) | 40.0% |
| Solvent (Alpha Methylstyrene) | 1.5% |
| Monomer (Diallyldimethylammonium chloride) | 0.2% |
| Monomer (Styrene) | 4.0% |
| Organofunctional silane | 0.05% |
| (Glycidoxypropyltrimethoxysilane) | |
| Polyether modified polydimethylsiloxane | 0.3% |
| Air Release Additive | 1% |
| Wetting and Dispersing Additive | 1.5% |
| Copper Napth 8% | 0.02% |
| 12% Cobalt Octoate | 0.08% |
| 15% Potassium | 0.08% |
| N,N-Diethyl aniline | 0.1% |
| Polymeric microspheres | 7% |
| Glass microspheres | 7% |

While certain representative embodiments and details have been shown for purposes of illustrating the invention, it will be apparent to those skilled in the art that various changes in the compositions and methods disclosed herein may be made without departing from the scope of the invention, which is defined in the appended claims.

1. An injectable coring composition comprising:
about 70 to about 90 wt % polyester resin;
about 0.1 to about 5 wt % monomer;
about 0.1 to about 5 wt % solvent;
about 1 to about 25 wt % spheres or microspheres, the spheres or microspheres made of glass, plastic, ceramic, or combinations thereof; and
0 to about 25 wt % filler.

2. The injectable coring composition of claim 1 further comprising a catalyst.

3. The injectable coring composition of claim 1 further comprising at least one additive selected from about 0.1 to about 5 wt % adhesion promoters, about 0.1 to about 5 wt % surface modifiers, about 0.1 to about 5 wt % air release additives, about 0.1 to about 5 wt % wetting and dispersing additives, about 0.1 to about 5 wt % accelerators, or combinations thereof.

4. The injectable coring composition of claim 1 wherein the polyester resin is selected from orthophthalic polyester resins, isophthalic polyester resins, dicyclopentadiene polyester resins, or combinations thereof.

5. The injectable coring composition of claim 1 wherein the polyester resin comprises about 40 to about 60 wt % orthophthalic polyester resin and about 20 to about 40 wt % dicyclopentadiene polyester resin.

6. The injectable coring composition of claim 1 wherein the polyester resin comprises about 30 to about 50 wt % orthophthalic polyester resin and about 30 to about 50 wt % dicyclopentadiene polyester resin.

7. The injectable coring composition of claim 1 comprising:
about 40 to about 60 wt % orthophthalic polyester resin;
about 20 to about 40 wt % dicyclopentadiene polyester resin;
about 0.1 to about 5 wt % monomer;
about 0.1 to about 5 wt % solvent;
about 0.1 to about 5 wt % adhesion promoter;
about 0.1 to about 5 wt % surface modifier;
about 0.1 to about 5 wt % accelerators;
about 1 to about 25 wt % spheres or microspheres, the spheres or microspheres made of glass and plastic; and
0 to about 25 wt % fillers.

8. The injectable coring composition of claim 7 further comprising a catalyst.

9. The injectable coring composition of claim 1 comprising:
about 30 to about 50 wt % orthophthalic polyester resin;
about 50 to about 50 wt % dicyclopentadiene polyester resin;
about 0.1 to about 5 wt % monomer;
about 0.1 to about 5 wt % solvent;
about 0.1 to about 5 wt % adhesion promoter;
about 0.1 to about 5 wt % surface modifier;
about 0.1 to about 5 wt % accelerators;
about 1 to about 25 wt % spheres or microspheres, the spheres or microspheres made of glass and plastic; and
0 to about 25 wt % fillers.

10. The injectable coring composition of claim 9 further comprising a catalyst.

11. The injectable coring composition of claim 1 wherein plastic spheres/microspheres are present in an amount from about 1 to about 10 wt %.

12. The injectable coring composition of claim 1 wherein glass spheres/microspheres are present in an amount from about 5 to about 18 wt %.

13. The injectable coring composition of claim 1 wherein ceramic spheres/microspheres are present in an amount of about 10 to about 25 wt %.

14. A method of making a core comprising:
providing an injectable resin composition comprising:
about 70 to about 90 wt % polyester resin;
about 0.1 to about 5 wt % monomer;
about 0.1 to about 5 wt % solvent;
about 1 to about 25 wt % spheres or microspheres, the spheres or microspheres made of glass, plastic, ceramic, or combinations thereof; and
0 to about 25 wt % filler,
adding a catalyst to the injectable resin composition;
injecting the injectable resin composition into a closed mold;
curing the injecting resin composition to form the core; and
removing the cured core.

15. The method of claim 14 wherein the injectable resin composition further comprises at least one additive selected from about 0.1 to about 5 wt % adhesion promoters, about 0.1 to about 5 wt % surface modifiers, about 0.1 to about 5 wt % air release additives, about 0.1 to about 5 wt % wetting and dispersing additives, about 0.1 to about 5 wt % accelerators, or combinations thereof.

16. The method of claim 14 wherein the polyester resin is selected from orthophthalic polyester resins, isophthalic polyester resins, dicyclopentadiene polyester resins, or combinations thereof.

17. The method of claim 14 wherein the polyester resin comprises about 40 to about 60 wt % orthophthalic polyester resin and about 20 to about 40 wt % dicyclopentadiene polyester resin.

18. The method of claim 14 wherein the polyester resin comprises about 30 to about 50 wt % orthophthalic polyester resin and about 30 to about 50 wt % dicyclopentadiene polyester resin.

19. The method of claim 14 wherein the injectable resin composition comprises:
about 40 to about 60 wt % orthophthalic polyester resin;
about 20 to about 40 wt % dicyclopentadiene polyester resin;
about 0.1 to about 5 wt % monomer,
about 0.1 to about 5 wt % solvent;
about 0.1 to about 5 wt % adhesion promoter;
about 0.1 to about 5 wt % surface modifier;
about 0.1 to about 5 wt % accelerators;
about 1 to about 25 wt % spheres or microspheres, the spheres or microspheres made of glass, plastic, ceramic, or combinations thereof, and
0 to about 25 wt % fillers.

20. The method of claim 14 wherein the injectable resin composition comprises:
about 30 to about 50 wt % orthophthalic polyester resin;
about 50 to about 50 wt % dicyclopentadiene polyester resin;
about 0.1 to about 5 wt % monomer,
about 0.1 to about 5 wt % solvent;
about 0.1 to about 5 wt % adhesion promoter;
about 0.1 to about 5 wt % surface modifier;
about 0.1 to about 5 wt % accelerators;
about 1 to about 25 wt % spheres or microspheres, the spheres or microspheres made of glass, plastic, or combinations thereof; and
0 to about 25 wt % fillers.

21. The method of claim 14 wherein plastic spheres/microspheres are present in an amount from about 1 to about 10 wt %.

22. The method of claim 14 wherein glass spheres/microspheres are present in an amount from about 5 to about 18 wt %.

23. The method of claim 14 wherein ceramic spheres/microspheres are present in an amount of about 10 to about 25 wt %.
